(19) United States
(12) Patent Application Publication
(10) Pub. No.: US 2026/0048501 A1
(43) Pub. Date: Feb. 19, 2026

(54) MANIPULATOR FOR AN INDUSTRIAL ROBOT WITH DUAL JOINTS ASSEMBLY

(71) Applicant: ABB SCHWEIZ AG, Baden (CH)

(72) Inventors: Ziwei Gao, Zhongshan (CN); Cong Yu, Zhuhai (CN); Feng Liang, Zhongshan (CN); Kangjian Wang, Shanghai (CN); Jiangang Li, Zhuhai (CN)

(21) Appl. No.: 19/368,021

(22) Filed: Oct. 24, 2025

Related U.S. Application Data
(63) Continuation of application No. PCT/CN2023/090383, filed on Apr. 24, 2023.

(51) Int. Cl. B25J 9/12

(52) U.S. Cl. CPC B25J 9/12

(57) ABSTRACT

A manipulator for an industrial robot. It includes at least one dual joints assembly including a housing including a first part defining a first chamber extending in a first axial direction and a second part defining a second chamber extending in a second axial direction orthogonal to the first axial direction. The first part is offset from the second part by a distance in a third axial direction orthogonal to the first axial direction and the second axial direction. A first joint is arranged within the first chamber and includes a first power output shaft configured to rotate around the first axial direction. A second joint is arranged within the second chamber and includes a second power output shaft configured to rotate around the second axial direction.

### FIELD

Embodiments of the present disclosure generally relate to a field of an industrial robot, and more specifically, to a manipulator with one or more dual joints assembly.

### BACKGROUND

Industrial robots are widely used in an industrial field. The industrial robot typically comprises a manipulator which includes a plurality of axial joints, for example, four, six, seven or more joints. An end effector may be fixed to an end flange of the manipulator to perform various tasks. Each axial joint allows an arm connected thereto to rotate in an axial direction. Through combination of the plurality of axial joints, the manipulator can be freely moved in the space. Within each joint, a number of components, such as a motor, a gearbox, a sensor, a brake and the like, are arranged to form the joint.

Due to the fact that there are many joints and each joint has many components, it is a time-consuming and labor intensive to assembly these components into the manipulator. Another problem is that when so many joints and so many components for the joint are assembled together, there is a risk that performances of the assembled manipulator are affected and in worst cases, the assembled manipulator cannot work properly since there are manufacturing tolerances for different components and operation differences among different workers.

So far, some designs have been proposed to improve configuration of the manipulator. For example, U.S. allowed U.S. Pat. No. 8,614,559B2, discloses a modular robot with a single joint module design. The CN pending publication No. 108890688A discloses an integral single joint with compact configuration. These designs, to some extent, can solve or mitigate the above problems. However, there is still a need to further improve the configuration of the industrial robot.

### SUMMARY

Example embodiments of the present disclosure provide a manipulator for an industrial robot with one or more dual joints assembly which can further simplify configuration of the manipulator.

In a first aspect of the present disclosure, there is provided a manipulator for an industrial robot. The manipulator comprises at least one dual joints assembly. The dual joints assembly comprises a housing comprising a first part defining a first chamber extending in a first axial direction and a second part defining a second chamber extending in a second axial direction orthogonal to the first axial direction, the first part being offset from the second part by a distance in a third axial direction orthogonal to the first axial direction and the second axial direction; a first joint arranged within the first chamber and comprising a first power output shaft configured to rotate around the first axial direction; and a second joint arranged within the second chamber and comprising a second power output shaft configured to rotate around the second axial direction.

Since two joints are integrated in one single housing, components of the manipulator can be reduced, with increased assembly efficiency and reduced manufacturing costs. Also, due to the fact that the first part being is from the second part by a distance in a third axial direction orthogonal to the first axial direction and the second axial direction, the first and second joints can be assembled in position within the housing without difficulty. This arrangement also ensures that the electrical components (such as motor) within the housing have improved thermal dissipation performances and there is no risk of overheating.

In some embodiments, the first part may comprise a first axial end comprising a first opening and a second axial end opposite to the first axial end in the first axial direction comprising a second opening. With this arrangement, components forming the first joint can be easily assembled within the inner chamber of the housing.

In some embodiments, the first opening may be of an elliptical shape, and the second opening may be of a circular shape. With this arraignment, the weight of the housing can be reduced while ensuring a structural strength of the housing.

In some embodiments, the manipulator may further comprise a first cover configured to enclose the first opening, and a structural member connected to the first power output shaft at the second opening. With this arrangement, the inner chamber of the housing can be enclosed at one end and the other axial end can be connected to the structural member.

In some embodiments, the first cover is made of a different material from the housing. With this arrangement, weight of the dual joints assembly can be reduced.

In some embodiments, the second part comprises a third axial end comprising a third opening and an fourth axial end opposite to the third axial end in the second axial direction comprising a fourth opening. With this arrangement, components forming the second joint can be easily assembled within the inner chamber of the housing.

In some embodiments, the manipulator may further comprise a second cover configured to enclose the third opening, and a second structural member connected to the second power output shaft at the fourth opening. With this arrangement, the inner chamber of the housing can be enclosed at one opening end and the other axial end can be connected to the structural member.

In some embodiments, the housing is a one-piece cast component produced by chill casting with sand core. With this arrangement, the housing can be produced.

In some embodiments, the first part and/or the second part is substantially of a cylindrical shape. This shape allows the rotation arrangement of the joint with a minimum form factor.

In some embodiments, the first part and the second part overlaps with each other in the third axial direction to define an overlapped part which defines a channel communicating the first chamber with the second chamber. The channel thus forms, for example, a path for cable connection.

In some embodiments, the first joint and the second joint each comprises: a motor; a rotation shaft coupled to the motor; and one or more sensors configured to sense a position of the rotation shaft.

In some embodiments, the manipulator may further comprise at least one structural member configured to connect two adjacent dual joints assembly or connect one dual joints assembly and a single joint assembly.

In a second aspect of the present disclosure, there is provided an industrial robot. The industrial robot comprises a base; and the manipulator according to any of the preceding claims.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic overall perspective view of an industrial robot according to one example embodiment of the present disclosure;

FIG. 2 is a perspective exploded view of the industrial robot shown in FIG. 1;

FIG. 3 is a partial sectional view of a dual joints assembly according to one example embodiment of the present disclosure;

FIG. 4 is a perspective view of the dual joints assembly according to one example embodiment of the present disclosure;

FIG. 5 is a plane view of the dual joints assembly of FIG. 4;

FIG. 6 is a perspective view of the dual joints assembly of FIG. 4, with the cover removed from the housing;

FIG. 7 is a perspective view of the dual joints assembly of FIG. 4 as viewed from a different view angle; and

FIG. 8 is a plane view of the dual joints assembly of FIG. 7.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to. ” The term “or” is to be read as “and/or” unless the context clearly indicates otherwise. The term “based on” is to be read as “based at least in part on. ” The term “being operable to” is to mean a function, an action, a motion or a state that can be achieved by an operation induced by a user or an external mechanism. The term “one embodiment” and “an embodiment” are to be read as “at least one embodiment. ” The term “another embodiment” is to be read as “at least one other embodiment. ” The terms “first,” “second,” and the like may refer to different or same objects. Other definitions, explicit and implicit, may be included below. A definition of a term is consistent throughout the description unless the context clearly indicates otherwise.

According to the present disclosure, a novel manipulator for an industrial robot is provided. The novel manipulator comprises one or more dual joints actuator which integrates two joints within a single housing. With this dual joints actuator, double motors (including a stator and a rotor), double brakes, double gearboxes, and the like can be arranged in a single housing of the dual joints actuator. Since the number of the components for manufacturing the manipulators is reduced, assembly efficiency can be improved, and manufactured costs can be reduced. Also, the weight of the manipulator can also be reduced which meets a lightweight design concept and requirements.

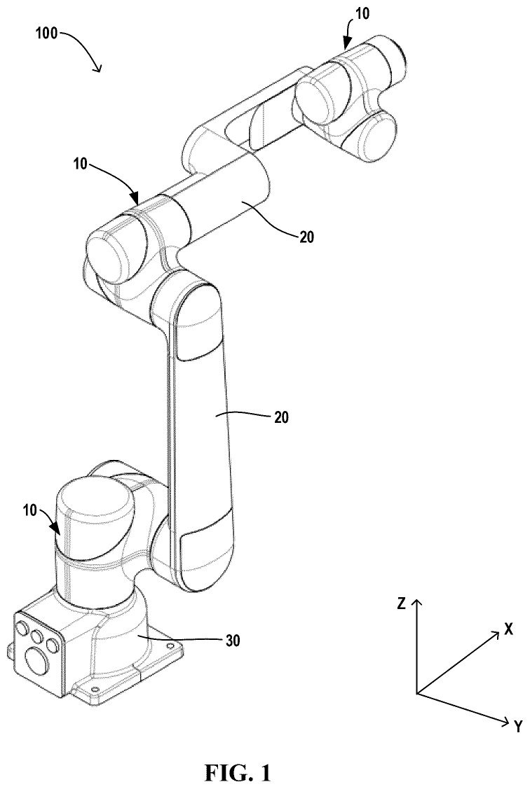

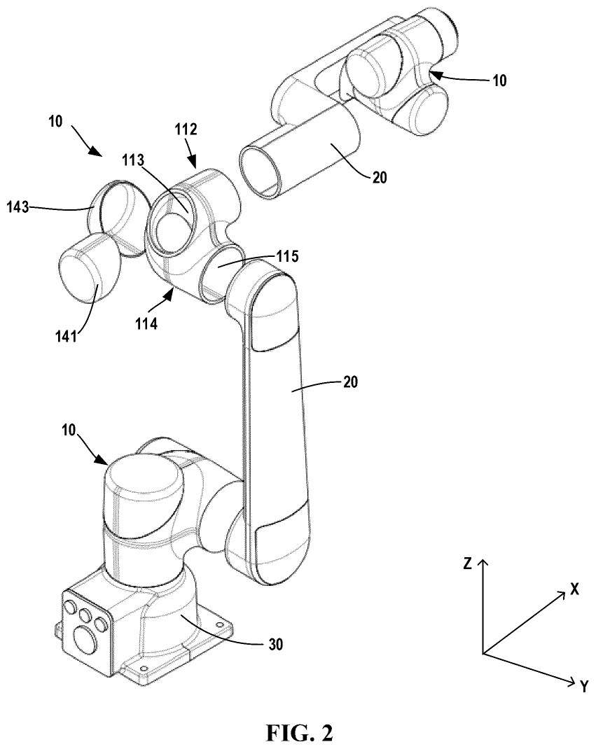

FIG. 1 is a schematic overall perspective view of an industrial robot 100 according to one example embodiment of the present disclosure; and FIG. 2 is a perspective exploded view of the industrial robot 100 shown in FIG. 1.

As shown in FIGS. 1 and 2, the industrial robot 100 includes a base 110, a plurality of dual joints assemblies 10 (also called dual joints actuator) and a plurality of structural members 20. In the shown example, the industrial robot 100 comprises three dual joints assemblies 10 and two structural members 20. The two structural members 20 are configured to connect two adjacent dual joints assemblies 10. Each dual joints assembly 10 comprises two joints each of which allow the structural member 20 connected thereto to rotate around an axial direction. The structural members may be of different length to realize desired reach of the working area of the industrial robot. In the shown example, the industrial robot is a 6-axis robot and a Cartesian coordinate system formed by X-axis, Y-axis, and Z-axis is also shown. It is to be understood that the shown example is merely illustrative and the industrial robot 100 may take other forms with different number of axes.

A controller may be provided in the base 30. Each dual joints assembly 10 comprises a monolithic housing 11. Within the monolithic housing 11, two inner chambers are defined for accommodating two sets of components of each joint, such as a motor, a double brake, a gearbox, and the like respectively. In this way, two joints can be integrated in one single housing 11. It makes possible to implement a manipulator with fewer components, which may further reduce the whole weight of the manipulator and realize a compact design. The dual joints assembly 10 may be assembled in advance and then the whole manipulator can be easily and quickly assembled. As for the 6-axis robot in the shown example, the manipulator only comprise 6 components, i.e., three dual joints assemblies 10 and two structural members 20. Complexity of the device is reduced, with increased efficiency and lower costs.

The structural members 20 and the housing 11 of dual joints assembly 10 are generally load bearing members for supporting loads applied on the robotic arm. An end flange may be provided at the distant end of the robotic arm. An end effector (not shown) may be fixed to the end flange. Through operation of the joints under control of the controller, the end flange and thus the end effector can be movable in space around the industrial robot 100 so as to automatically perform various tasks base on instructions from the controller. In the shown example, the industrial robot is shown as a collaborative robot. The collaborative robot may be provided with various technical features to perform tasks in collaboration with engineers in industrial sectors. It is to be understood that the industrial robot may be of any other types of robots besides the collaborative robot.

As shown in FIG. 2, the housing 11 of dual joints assembly 10 comprises a first part 112 and a second part 114. The first part 112 and the second part 114 are different portions of the monolithic housing 11. The first part 112 defines a first chamber 113 extending in a first axial direction X. The first part 112 may include openings for receiving the joint. A cover 141 may be provided to enclose the opening. Likewise, the first part 114 may include openings for receiving the joint. Covers 141, 143 may be provided to enclose the opening. The covers may be made of different material from the housing 11 and the structural member 20. In some embodiments, the cover may be made of lightweight material, such as plastic material. In this case, the weight of the whole dual joints assembly 10 can be further reduced.

A first joint (not shown) is arranged within the first chamber 113. A power output shaft of the first joint is connected to the structural member 20 (the lower member indicated by reference sign 20 in FIG. 2) so as to drive the structural member 20 to rotate around the axial direction X. The second part 114 defines a second chamber 115 extending in a second axial direction Y orthogonal to the first axial direction X. A power output shaft of the second joint is connected to the structural member 20 (the upper member indicated by reference sign 20 in FIG. 2) so as to drive the structural member 20 to rotate around the axial direction Y. The first part 112 is offset from the second part 114 by a distance in a third axial direction Z orthogonal to the first axial direction X and the second axial direction Y. By this offset arrangement in the axial direction Z, it makes it possible to place the components for each joint in the respective chambers within the single monolithic housing 11. Moreover, when the components within the housing fail, maintenance and/or replacement of these components can be performed without difficulty. Also, electrical components (such as motor) within the housing have improved thermal dissipation performances and there is no risk of overheating.

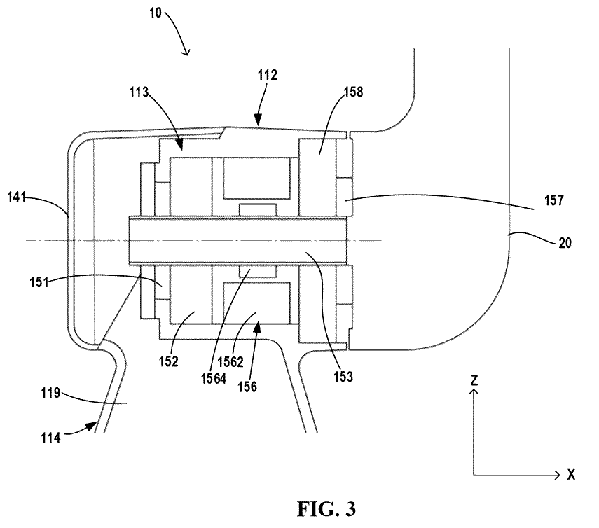

FIG. 3 is a partial sectional view of a dual joints assembly 10 according to one example embodiment of the present disclosure. FIG. 3 shows one exemplary arrangement of one joint within the housing. In the shown example, structural details of the first joint are shown. The second joint may be analogously arranged within the second chamber. As shown in FIG. 3, a rotation shaft 153 is arranged within the chamber 113 of the first part 112 and extends in the axial direction X. A motor 156 comprises a stator 1562 and a rotor 1564. The rotor 1564 is fixedly connected to the rotation shaft 153. A gearbox 158 is coupled to the rotation shaft 153 to achieve a desired speed ratio and the output of the gearbox 158 is connected to the structural member 20 via a coupler 157. Through the drivetrain formed by the motor and the gearbox, the structural member 20 can be actuated.

Components, such as sensors and brakes, may also be provided within the chamber to realize precise control of the structural member in cooperation with the controller. In the shown embodiments, a position sensor 151 is provided and is configured to sense angle displacement or rotation speed of the rotation shaft 153. Data from the sensor 151 can be transmitted to the controller. In addition or alternatively, a brake 152 may be provided to stop rotation of the rotation shaft 153. In some embodiments, a torque sensor may be provided to detect the torque applied on the rotation shaft 153. It is to be understood that the shown structural details of the joint is merely illustrative and the joint may take any other proper configuration with fewer or more components.

In some embodiments, as shown in FIG. 3, the first part 112 may be connected to the second part 114 by a connection part. The connection part may define a channel 119 communicating the first chamber 113 with the second chamber 115. Cables for powering the components within the chambers and/cables for communication can lead through the channel 119 inside the manipulator. In some embodiments, the connection part may be an overlapped part between the first part 112 and the second part 114 in the axial direction Z. In this case, the size of the dual joints assembly can be reduced. Moreover, with the overlapped part, the weight of the whole manipulator can be further reduced.

The monolithic housing 11 may be formed as various shapes as long as the two sets of the driving arrangement, including the motor and the associated components, can be assembled within the respective chambers defined in the housing. The housing 11 is a one-piece cast component, in particular, produced by chill casting with sand core.

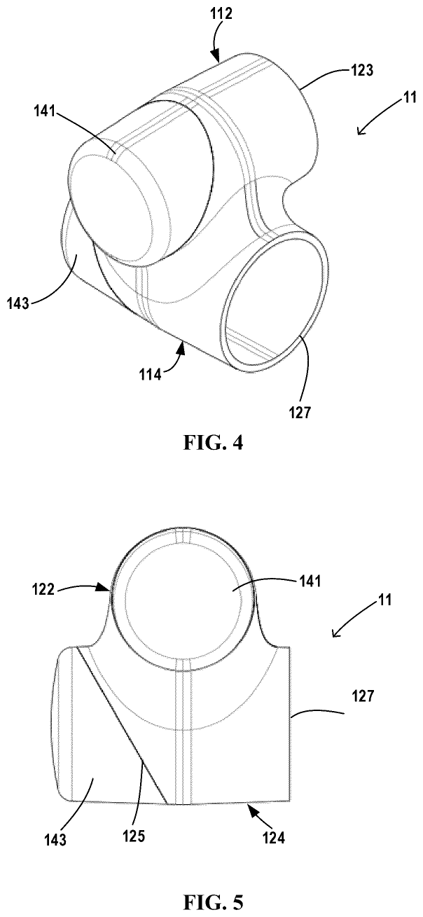

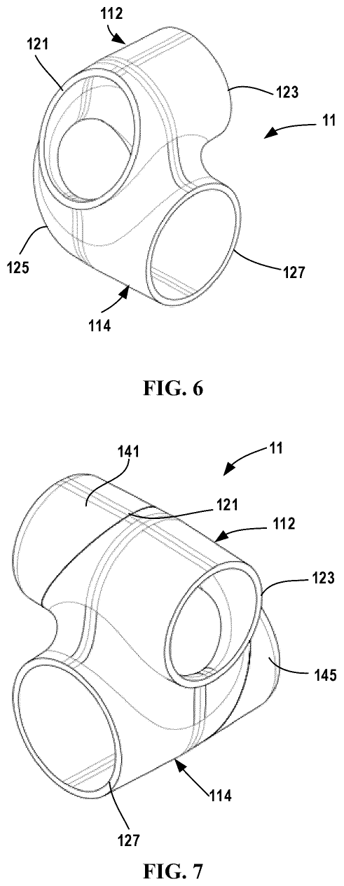

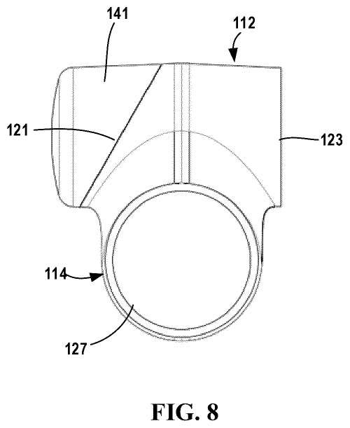

FIGS. 4-8 show views of a housing of the dual joints assembly according to one example embodiment. In the shown example, the first part 112 is substantially of a cylindrical shape and defines a hollow inner chamber 113. Likewise, the second part 114 is substantially of a cylindrical shape and defines a hollow inner chamber 115. It is to be understood that the shapes of the first part 112 and the second part 114 are merely illustrative and the first part 112 and the second part 114 can be formed as any other proper shapes.

As shown in FIGS. 4-8, the first part 112 comprises a first axial end and an opposite second axial end along the axial direction X. A first opening 121 may be provided at first axial end, and a second opening 123 may be provided at the second axial end. During assembly of the joints, driving arrangement of the first joint, such as the motor and the associated components, can be placed in the inner chamber 113 via the openings 121, 123. Since the two openings provide easy access to the inner portion of the first part 112, a worker can assembly the joint without difficulty.

As shown in FIGS. 4, 5, 7, and 8, a first cover 141 may be provided at the first axial end to enclose the first opening 121. With the first cover 141, the inner components within the first chamber can be prevented from exposing to the user. The first cover 141 may be formed of lightweight material, for example, plastic material. The first opening 121 may be of various shapes. In some embodiments, the first opening is of an elliptical shape. With this shape, access to the inside of the chamber can be further improved. Also, since the housing is generally made of rigid member, the elliptical shape of the first opening may facilitate reduction material of the housing without comprising strength of the housing and the weight of the dual joints assembly can further be reduced. The second opening 123 is as a connection interface and configured to receive the structural member 20. The structural member 20 is configured to be fixed to the drivetrain of the joint at the second axial end. In the shown example, the second opening 123 is of a circular shape. It is to be understood that this is merely illustrative and the second opening may be formed as any other proper shapes.

Likewise, as shown in FIGS. 4-8, the second part 114 comprises a third axial end and an opposite fourth axial end along the axial direction Y. A third opening 125 may be provided at first axial end, and a fourth opening 127 may be provided at the fourth axial end. During assembly of the joints, driving arrangement of the second joint, such as the motor and the associated components, can be placed in the inner chamber 115 via the openings 125, 127.

As shown in FIGS. 4, 5, 7, and 8, a second cover 143 may be provided at the third axial end to enclose the third opening 125. With the second cover 143, the inner components within the second chamber can be prevented from exposing to the user. The second cover 143 may be formed of lightweight material, for example, plastic material. The third opening 125 may be of various shapes. In some embodiments, the third opening 125 is of an elliptical shape. With this shape, access to the inside of the chamber can be further improved. Also, the elliptical shape of the third opening may facilitate reduction material of the housing without comprising strength of the housing and the weight of the dual joints assembly can further be reduced. The fourth opening 127 is used as a connection interface and is configured to receive the structural member 20. The structural member 20 is configured to be fixed to the drivetrain of the joint at the second axial end. In the shown example, the fourth opening 127 is of a circular shape. It is to be understood that this is merely illustrative and the fourth opening may be formed as any other proper shapes.

In some embodiments, as shown in FIGS. 4-8, the first part 112 and the second part 114 overlaps with each other in the axial direction Z to define an overlapped part 117. The overlapped part 117 is also a transition part between the first part 112 and the second part 114. A hollow channel 119 may be defined in the overlapped part 117 and the hollow channel 119 communicates the first chamber 113 in the first part 112 with the second chamber the second part 114. Electrical components, such as cables for powering and cables for communications may lead through the hollow channel 119. In the shown example, the first part 112 and the second part 114 overlaps with each other in the third axial direction Z. In some embodiments (not shown), the first part 112 may be connected to the second part 114 by a hollow connection bridge extending in the axial direction Z which defines a channel.

According to the present disclosure, a dual joints assembly is provided and two joints are assembled in a monolithic housing. Openings are provided in the monolithic housing and can be used as interfaces for assembling the components of the two joints. Some openings may also be used as connection interfaces for connecting the structural members. Accordingly, a compact dual joints assembly can be realized. With the dual joints assembly, the number of the components for forming the manipulator is reduced, resulting high assembly efficiency and low manufacturing costs.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A manipulator for an industrial robot, comprising at least one dual joints assembly, comprising:
a housing comprising a first part defining a first chamber extending in a first axial direction and a second part defining a second chamber extending in a second axial direction orthogonal to the first axial direction, the first part being offset from the second part by a distance in a third axial direction orthogonal to the first axial direction and the second axial direction;
a first joint arranged within the first chamber and comprising a first power output shaft configured to rotate around the first axial direction; and
a second joint arranged within the second chamber and comprising a second power output shaft configured to rotate around the second axial direction.

2. The manipulator according to claim 1, wherein the first part comprises a first axial end comprising a first opening and a second axial end opposite to the first axial end in the first axial direction comprising a second opening.

3. The manipulator according to claim 2, wherein the first opening is of an elliptical shape, and the second opening is of a circular shape.

4. The manipulator according to claim 2, further comprising:
a first cover configured to enclose the first opening, and
a structural member connected to the first power output shaft at the second opening.

5. The manipulator according to claim 4, wherein the first cover is made of a different material from the housing.

6. The manipulator according to claim 1, wherein the second part comprises a third axial end comprising a third opening and an fourth axial end opposite to the third axial end in the second axial direction comprising a fourth opening.

7. The manipulator according to claim 6, further comprising:
a second cover configured to enclose the third opening and
a second structural member connected to the second power output shaft at the fourth opening.

8. The manipulator according to claim 1, wherein the housing is a one-piece cast component produced by chill casting with sand core.

9. The manipulator according to claim 1, wherein the first part and/or the second part is substantially of a cylindrical shape.

10. The manipulator according to claim 1, wherein the first part and the second part overlaps with each other in the third axial direction to define an overlapped part which defines a channel communicating the first chamber with the second chamber.

11. The manipulator according to claim 1, wherein the first joint and the second joint each comprises:
a motor;
a rotation shaft coupled to the motor; and
one or more sensors configured to sense a position of the rotation shaft.

12. The manipulator according to claim 1, further comprising at least one structural member configured to connect two adjacent dual joints assembly or connect one dual joints assembly and a single joint assembly.

13. An industrial robot, comprising:
a base; and
the manipulator according to claim 1.
